(19) United States
(12) Patent Application Publication
(10) Pub. No.: US 2010/0301608 A1
(43) Pub. Date: Dec. 2, 2010

(54) MAGNETICALLY DRIVEN MOTOR AND ELECTRIC POWER GENERATOR

(76) Inventor: Garland Rush, Sonoma, CA (US)

Correspondence Address: STAINBROOK & STAINBROOK, LLP, 412 AVIATION BOULEVARD, SUITE H, SANTA ROSA, CA, 95403, US

(21) Appl. No.: 12/791,780

(22) Filed: Jun. 1, 2010

Related U.S. Application Data
(60) Provisional application No. 61/182,673, filed on May 29, 2009.

(51) Int. Cl. H02K 47/04; H02K 7/09; H02K 11/00; H02P 9/02; H02K 53/00

(52) U.S. Cl. 290/50; 310/113; 310/90.5; 310/68 B; 415/916

(57) ABSTRACT

Method and apparatus for powering an electric power generator by circumferentially positioning an array of drive magnets on a rotor and positioning a series of electromagnets on a platform surrounding the drive magnets. The electromagnets are energized and provided with a repulsive polarity at exact time and position necessary to repel a corresponding drive magnet on the rotor so as to drive the rotor in one direction. The rotor includes arrays of permanent magnets that induce current in wire coils circumferentially disposed in one or more stators around and in close proximity to the induction magnets.

### CROSS REFERENCES TO RELATED APPLICATIONS

The present application claims the benefit of the filing date of U.S. Provisional Patent Application Ser. No. 61/182,673, filed May 29, 2009 (May 29, 2009).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### SEQUENCE LISTING

Not applicable.

### BACKGROUND OF THE INVENTION

1. Field of the Invention

The present invention relates generally to electric motors, electric generators, and electric power generation, and more particularly to a magnetically driven motor and electric power generator.

2. Discussion of Related Art Including Information Disclosed Under 37 CFR §§1.97, 1.98:

Optimal mechanical efficiency and power conservation in electric motors and electric power generators is an implicit and tacit objective, yet it is of paramount importance. Indeed, it is in the very nature of such machines to be efficient. To that end, a well known means of improving efficiency in motors has been through the reduction of friction between moving parts in contact with one another. Most often that is achieved by introducing a lubricant between the parts.

Another objective, now also of paramount importance, is that of being environmentally clean. To that end, it is increasingly desirable to employ only those engines and motors that provide motive force, and electrical power generators that provide electrical energy, without the consumption of fossil fuels.

### BRIEF SUMMARY OF THE INVENTION

The present invention harnesses the energy contained in the magnetic fields of permanent magnets to drive an electric motor and power generator. More specifically, the present invention provides a way to power an electric power generator by exploiting the motive force available when two magnets having identical polarity are brought into proximity. In the present invention, this is accomplished by circumferentially positioning an array of permanent magnets (“drive magnets”) on a rotor and positioning a series of electromagnets on a platform surrounding the drive magnets. The electromagnets are energized and provided with a repulsive polarity only at the exact time and position necessary to repel a corresponding drive magnet on the rotor so as to drive the rotor in one direction. The rotor includes one or more other circumferentially disposed arrays of permanent magnets (electrostatic “induction magnets”), as well, but these other sets of magnets are employed to induce current in circumferentially disposed wire coils in proximity to the induction magnets. The motor is capable of running on its own power after reaching sufficient rotation speed for the magnets and coils employed, and while energy production is limited to the energy available in the magnetic fields provided by the drive magnets, this motor design allows users to convert that energy into the mechanical energy required to drive a generator, which, in turn, is converted into electrical energy that may be stored in batteries and used at a later time. In its most essential aspect, therefore, the present invention provides a highly efficient and environmental friendly electric power generator for converting the power available in magnetic fields to electric power for storage and later use.

### BRIEF DESCRIPTION OF THE SEVERAL VIEWS OF THE DRAWINGS

FIG. 1 is a schematic exploded perspective view of the magnetically driven motor and electric power generator of the present invention;

FIG. 1A is a schematic perspective view showing a partial assembly thereof;

FIG. 1B is a schematic perspective view showing a full assembly thereof;

FIG. 2 is a schematic detailed perspective view taken along section line 2 of FIG. 1, showing detail of the elongate permanent disposed in the rotor;

FIG. 3 is a schematic detailed perspective view taken along section line 3 of FIG. 1, showing detail of the elongate electromagnets employed in the inner stator;

FIG. 4A is a schematic n upper perspective view showing a second preferred embodiment of the magnetically driven motor and electric power generator of the present invention;

FIG. 4B is a schematic exploded view thereof; and

FIG. 5 is a schematic upper perspective view of a third preferred embodiment of the magnetically driven motor and electric power generator of the present invention;

FIG. 6 is a schematic exploded upper perspective view of a fourth preferred embodiment of the motor and electric power generator of the present invention;

FIG. 7 is an upper perspective view thereof;

FIG. 8 is a lower exploded perspective view showing the lower portion of the apparatus without the stators shown; and

FIG. 9 is an upper perspective view showing an alternative embodiment of the apparatus of FIGS. 6-8, in which the ring of electromagnets has been replaced by a linear induction motor ring.

### DETAILED DESCRIPTION OF THE INVENTION

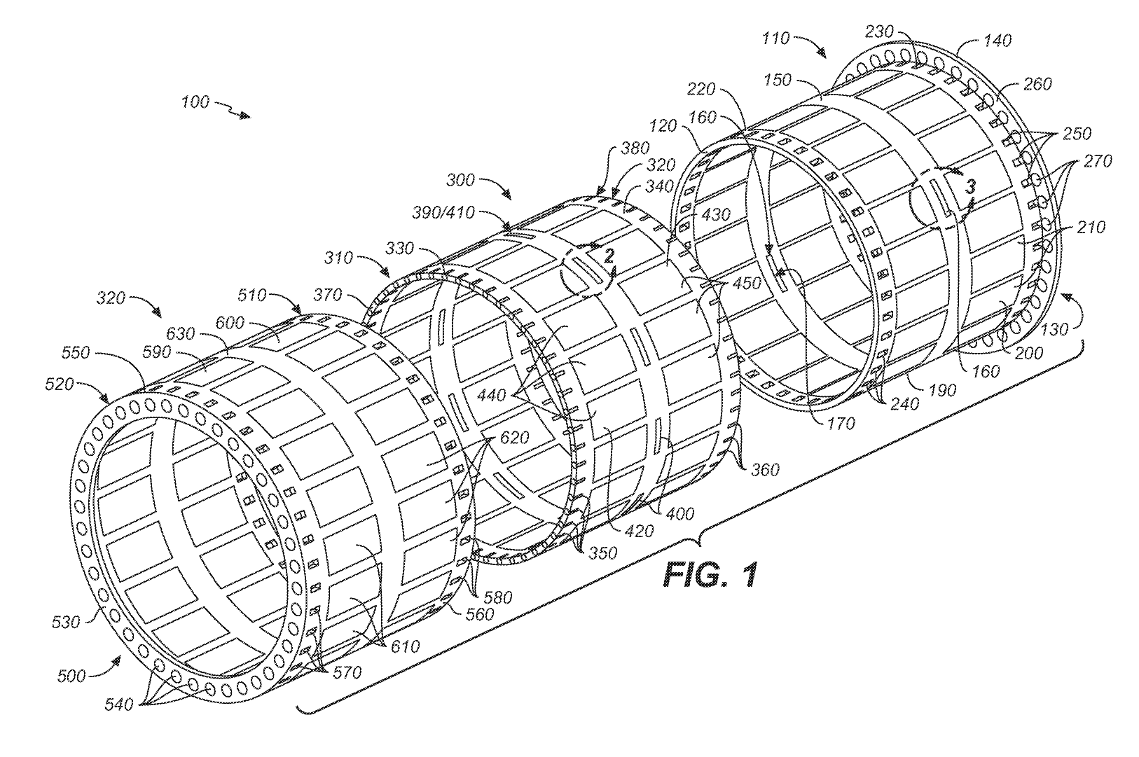

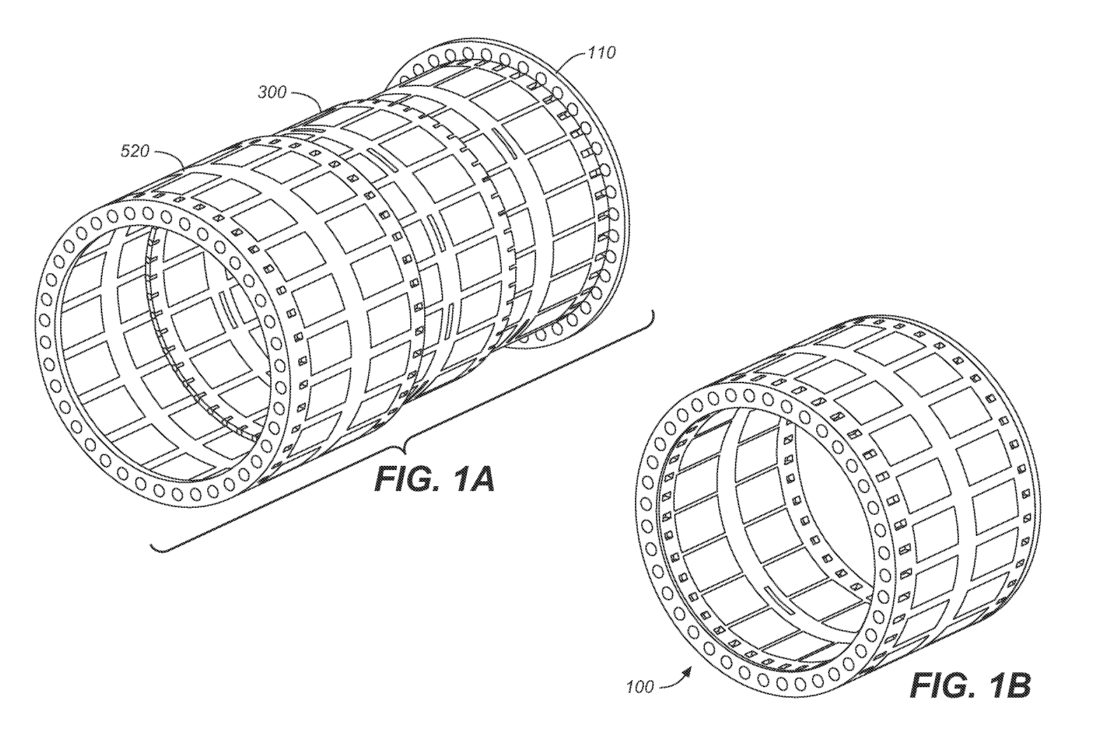

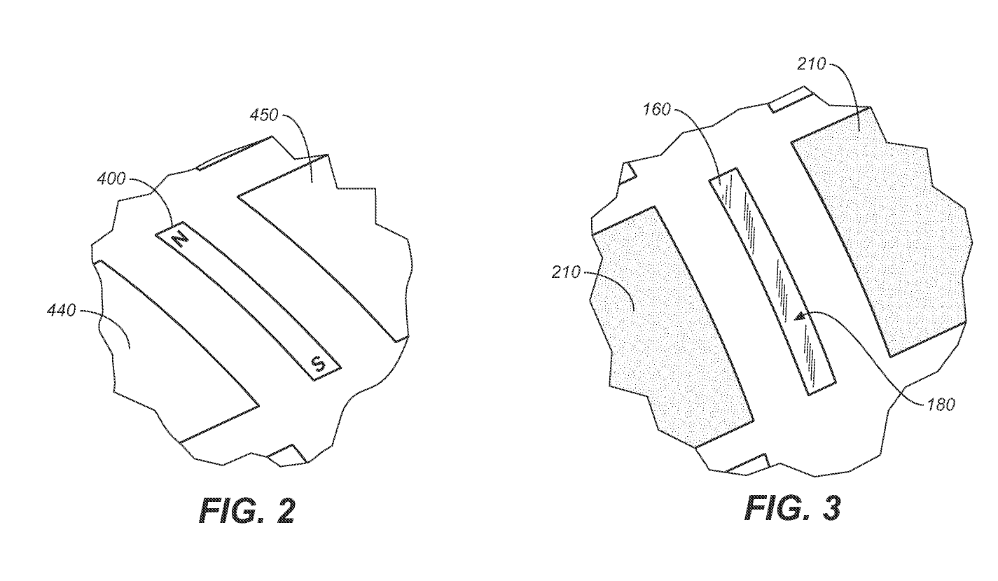

Referring first to FIGS. 1 through 3, wherein like reference numerals refer to like components in the various views, there is illustrated therein a first preferred embodiment of a new and improved magnetically driven motor and electric power generator, generally denominated 100 herein. Collectively, these figures show that the inventive apparatus comprises a generally cylindrical inner stator 110 having an outside diameter (not indicated by a reference number), a proximal end 120 and a distal end 130, an outwardly projecting flange or rim 140 disposed at the distal end, a circumferential midline 150, and a plurality of arcuate elongate electromagnets 160 embedded in the body of the inner stator along the circumferential midline such that both inner surface 170 (see FIG. 1) and outer surface 180 (see FIG. 3), respectively, are exposed or only lightly protected by a thin layer of non-ferrous material. The inner stator next includes first and second coil rows 190, 200, each having a plurality of circumferentially disposed coil windings 210. Each row of windings is disposed on one side of the circumferential midline. In addition, the inner stator includes proximal and distal levitation magnet rings 220, 230, respectively, each including a plurality of spaced apart magnets, 240, 250, circumferentially disposed in proximity to the proximal and distal ends of the inner stator. Finally, the inner stator includes a levitation magnet ring 260 comprising a plurality of levitation magnets disposed in the outwardly projecting flange 140.

Next, the electric generator apparatus includes a substantially cylindrical rotor 300 having an inside diameter and an outside diameter (not indicated by reference numbers), the inside diameter slightly larger than the outside diameter of the inner stator, such that the inner stator can be slidably inserted into the rotor with an acceptable clearance for free rotation, and optimal magnetic levitation relative to both the inner stator and the outer stator 500 (the latter to be described in detail below), and optimal induction during operation (also to be described below). The rotor has a proximal end 310 and a distal end 320, a proximal and distal levitation magnet ring 330, 340, each disposed in one end of the rotor. Each ring includes a plurality of levitation magnets 350, 360, with one pole (one end) of all magnets exposed or substantially exposed at the rim 370, 380 of the respective end of the rotor, such that the levitation magnets 380 in the rotor distal end will be repelled by both the levitation magnets 250 in the distal end 130 and the levitation magnets 270 in the outwardly projecting flange 140 of the inner stator 110; likewise, the levitation magnets 370 in the rotor proximal end 310 will be repelled by corresponding rings of levitation magnets in the proximal end and inwardly projecting flange of the outer stator 500, fully described below.

Next, the rotor includes a ring 390 of elongate arcuate permanent magnets 400 circumferentially disposed around the circumferential midline 410 of the rotor, as well as two rows 420, 430 of permanent magnets 440, 450 circumferentially disposed around the rotor at each side of the circumferential midline. When the inner stator is inserted into the rotor, the rotor circumferential midline 410 is concentric with the inner stator circumferential midline 150, thereby bringing the rotor's ring 390 and rows 420, 430 of permanent magnets into concentric alignment with the electromagnets 160 and rows 190, 200 of coil windings in the inner stator 110. At the same time, the levitation magnets of the rotor are brought into concentric alignment with the levitation magnets in the inner stator. The magnets are preferably neodymium, though other rare earth magnets are also suitable. They may be embedded or framed in the rotor shell and exposed on the sides, but preferably the magnets are covered by a thin layer of material, preferably carbon fiber, on the outer circumference (so as to resist displacement under the influence of centrifugal force during high speed rotation). It should also be noted that magnets in each of the rings and rows have their poles aligned identically to the other magnets in the respective row or ring.

Next, the inventive magnetically driven electric generator includes a substantially cylindrical outer stator 500. This element in the assembly includes an inside diameter and an outside diameter (not indicated by reference numbers), the inside diameter being slightly larger than the outside diameter of the rotor, such that the rotor can be slidably inserted into the outer stator with an acceptable clearance for free rotation of the rotor within the outer stator, for optimal magnetic levitation of the rotor relative to the outer stator, and for optimal induction during operation. The outer stator includes a proximal end 510 and a distal end 520, and an inwardly projecting flange 530 disposed at the distal end with a plurality of levitation magnets 540 disposed in the flange. Proximal and distal levitation magnet rings 550, 560, respectively, are each disposed in close proximity to one end of the outer stator. Each ring includes a plurality of levitation magnets 570, 580, such that the levitation magnets, 540, 580 in the outer stator distal end 520 will be repelled by the levitation magnets 360 in the distal end 320 of the rotor 300; likewise, the levitation magnets 540 and 570 in the outer stator proximal end 510 will be repelled by the corresponding ring of levitation magnets 350 in the proximal end 310 of the rotor.

The outer stator includes two rows 590, 600 of coil windings 610, 620, circumferentially disposed at either of one side of the circumferential midline 630 of the outer stator. Thus, when the inner stator is inserted into the rotor, and the rotor, in turn, is inserted into the outer stator, the outer stator circumferential midline 630 is concentric with the inner stator circumferential midline 150, and the rotor's circumferential midline 410, thereby bringing the rotor's rows 420, 430 of permanent magnets 440, 450 into concentric alignment with the rows 590, 600 of windings in the outer stator 500. At the same time, the levitation magnets of the rotor are concentrically aligned with the levitation magnets in the outer stator.

Principle of Operation: The clearance provided between the rotor and both the inner stator and outer stator allows for levitation of the rotor under the influence of the constellation of levitation magnets. The magnetically suspended rotor is driven by timed electro-magnetic pulses delivered to the electromagnets 160 in the inner stator 110 from a power control unit (not shown, but well known in the art). When energized, the electromagnets repel the permanent magnets 400 in the rotor 300, which creates electron flow as the larger neodymium magnets 440, 450 pass the inner stator coil windings 210, 220 and the outer stator coil windings 590, 600. This flow increases with increased RPMs, as in standard generators. The energy source of ongoing operation of the electromagnetic drive is eventually drawn from the current created by the generator itself and uses only a fraction of the generator output for this purpose.

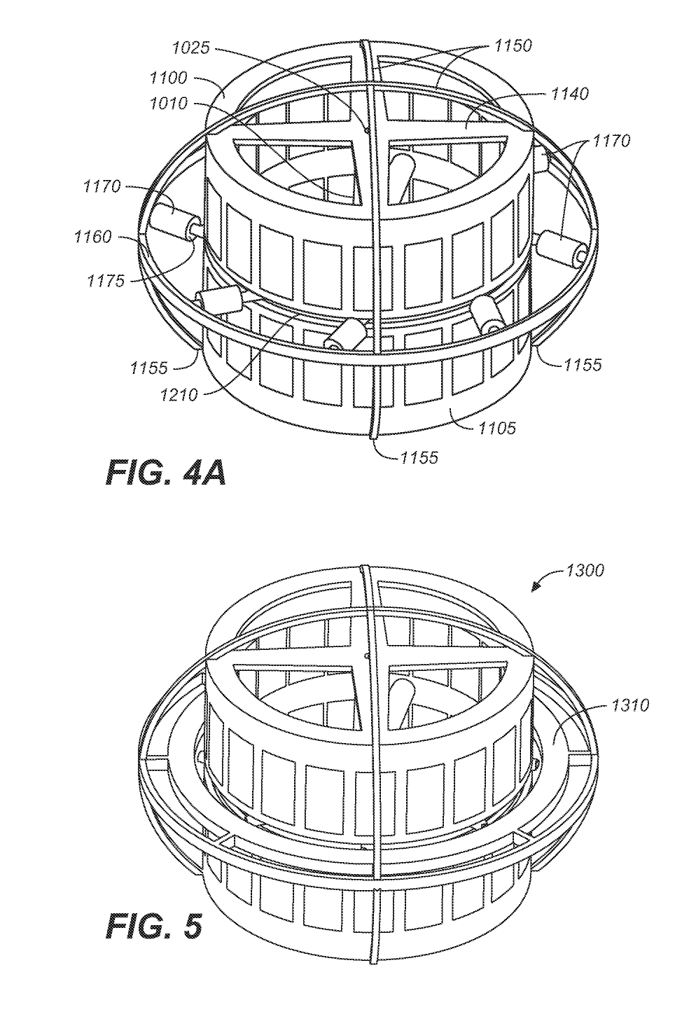

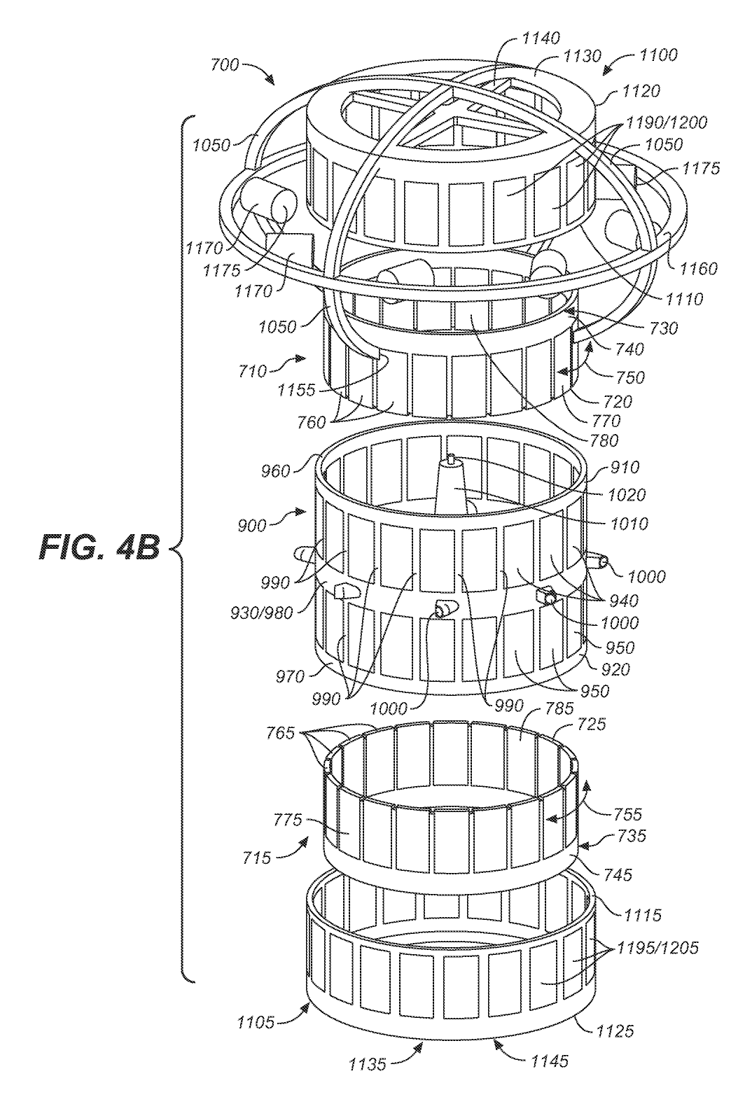

Referring next to FIGS. 4A and 4B, there is shown a second preferred embodiment of the magnetically driven motor and electric power generator of the present invention. This embodiment in its entirety bears reference number 700 herein. Collectively, these figures show that the inventive apparatus comprises generally cylindrical upper and lower inner stators 710, 715, respectively, each having a proximal end 720, 725, a distal end 730, 735, an annular structural ring formed in the distal end 740, 745, an outer circumferential dimension 750, 755, and a plurality of coil windings 760, 765 embedded in the annular structural ring or otherwise affixed to the body of its respective inner stator in an array of columns or rows such that both the inner and outer surfaces 770, 775, and 780, 785, respectively, of the coil containers are exposed or only lightly protected by a thin layer of non-ferrous material.

Next, the inventive magnetic electric generator apparatus includes a substantially cylindrical rotor 900 having an inside diameter and an outside diameter (not indicated by reference numbers), the inside diameter slightly larger than the outside diameter or outside circumferential dimension of the upper and lower inner stators, such that the inner stators insert into the rotor with an acceptable clearance for free rotation, and optimal magnetic levitation relative to both the upper and lower outer stators 1100, 1105 (the latter elements to be described in detail below), and optimal induction during operation (also to be described below). The rotor has an upper end 910 and a lower end 920, and a circumferential midline 930. An upper and lower row of permanent magnets 940, 950 are each arrayed in rows on the upper and lower sides, respectively, of the circumferential midline. Upper and lower structural rings 960, 970 integrally connect with a medial circumferential ring 980 with vertical slats 990 to form the framework within which the magnets are disposed.

Next, it will be seen that a plurality of permanent magnets 1000 are circumferentially disposed around the circumferential midline 930 and medial ring 980 of the rotor. The magnets are oriented with exposed poles angled rearwardly relative to the direction of rotation of the rotor. An axially oriented spindle 1010 having a center axle 1020 spans the distance from the upper to lower edges of the rotor and is affixed to the medial ring with radially extending spokes or a concentrically disposed solid plate or disk (not shown) which connects to the inner wall of the rotor at the circumferential midline.

Next, the inventive magnetically driven electric generator includes substantially cylindrical upper and lower outer stators 1100, 1105. Each outer stator in the assembly includes an inside diameter and an outside diameter (not indicated by reference numbers), the inside diameters being slightly larger than the outside diameter of the rotor, such that the rotor inserts into the outer stators with an acceptable clearance for free rotation of the rotor within the outer stators, and for optimal magnetic levitation of the rotor relative to the outer stators, and for optimal induction during operation. The upper and lower outer stators each include a proximal end 1110, 1115 and a distal end 1120, 1125, and an inwardly projecting ring or cap 1130, 1135 disposed at the respective distal ends and to which the upper and lower inner stators are affixed in a spaced apart relationship such that the rotor is disposed between the inner stators and outer stators with a small clearance.

Each of the upper and lower outer stators also includes either cross members 1140, 1145 or end plates having, both possible structures including a center bearing or bushing 1025 in which each end of axle 1020 is journalled. A plurality of outwardly extending arches 1050 connect to the upper cap 1130 of the upper outer stator 1100 and arc downwardly to a terminus 1155 generally coplanar with the cap 1135 on lower outer stator 1105.

A support ring 1160 is attached or integrally affixed to the arches for structural support and to provide a structural element for affixing a plurality of electromagnets 1170, which angle away from the direction of rotation of the rotor so as to orient the magnetic pole 1175 (which is opposite the exposed pole of permanent magnets 1000 on rotor 900), such that the permanent magnets 1000 on rotor 900 are repelled and driven by the electromagnets 1170 in support ring 1160.

The upper and lower outer stators each include a row 1190, 1195, respectively, of coil windings 1200, 1205, circumferentially disposed around the stators and having exposed sides, in the same manner as those of the inner stators. Thus, when the rotor is inserted between the upper and lower inner and outer stators and the axle journalled in the upper and lower bushings, the rotor circumferential midline 930 is concentric with the support ring 1160, thereby bringing the rotor's permanent magnets 1000, into concentric alignment with electromagnets 1170, and the upper and lower inner and outer stators are held in a spaced apart relationship, the former to accommodate and allow movement of the center plate or spokes 1140 extending from spindle 1010, and the latter to accommodate and allow free movement of the rotor. The space or gap 1210 between the upper and lower outer stators is shown in FIG. 4A.

Referring now to FIG. 5, there is shown a third preferred embodiment 1300 of the inventive magnetically driven motor and electric power generator of the present invention. In this embodiment all of the structural and operative elements are identical to those of the second preferred embodiment, except that electromagnets 1170 are replaced by a high speed linear synchronous motor or linear induction motor ring (LSM ring) 1310 comprising a plurality of electromagnets configured in an annular array. In effect, this is the same device as that shown in FIGS. 4A-4B, but includes a substantially continuous ring of electromagnets rather than an array of a relatively small or limited number of spaced apart magnets.

In either of the second and third embodiments shown in FIGS. 4 through 5, respectively, the electromagnets may be pulsed (that is, turned on and off) in a sequence. Additionally, they can be provided with power in a precise manner so as to control the rotation speed of the rotor. The electric pulses can be timed by a circuit that includes optical infrared sensors disposed around the circumferential LSM ring 1310 or support ring 1160, and which sense the proximity of a surface of magnets 1000, adjusting the pulse timing according to the then current speed of the rotor.

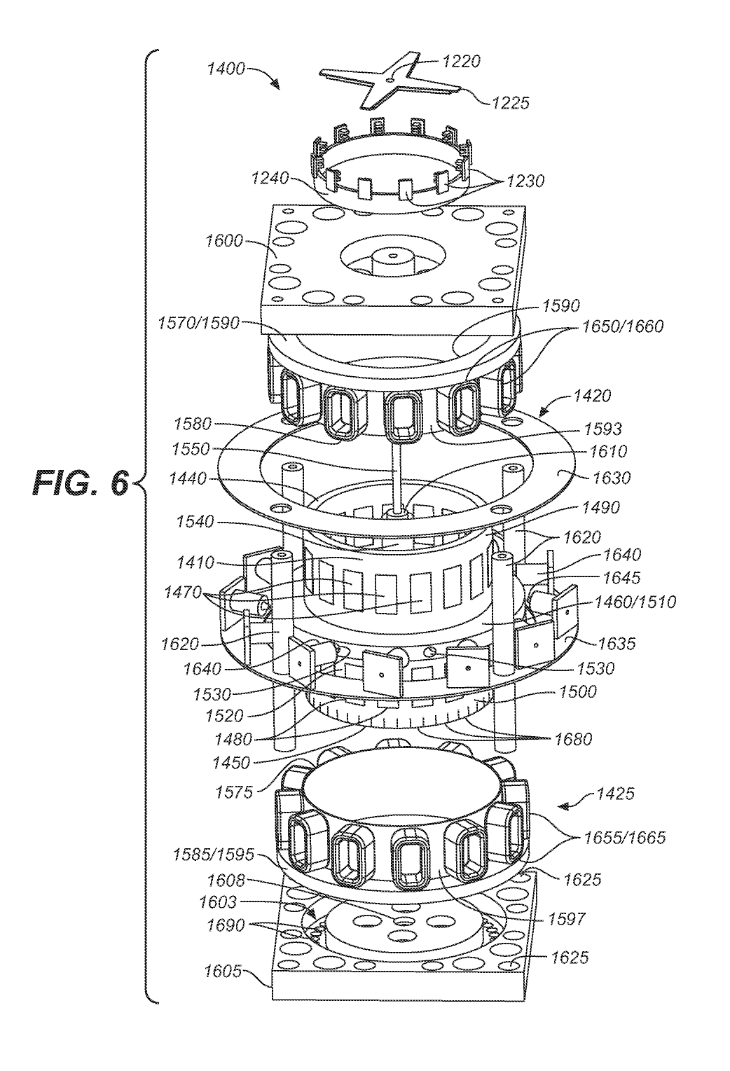

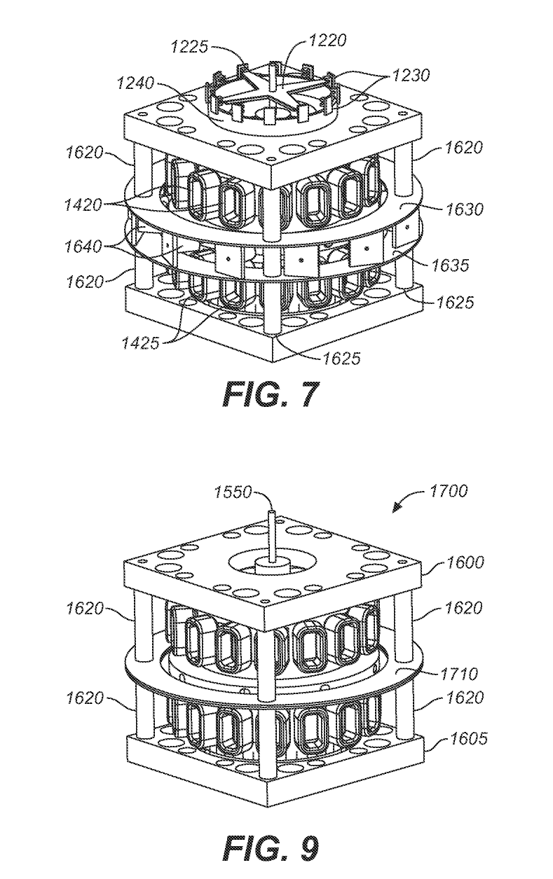

Referring next to FIGS. 6-8, there is shown a fourth preferred embodiment of the magnetically driven motor and electric power generator of the present invention, generally denominated 1400 herein. In this embodiment, the inventive apparatus includes generally cylindrical upper and lower stators 1420, 1425, respectively, each having a proximal (upper) edge or end 1570, 1575 (as viewed from the top down), a distal (lower) edge or end, 1580, 1585 an annular structural mounting ring, 1590, 1595, first and second sets 1650, 1655, respectively, of coil windings, 1660, 1665, circumferentially disposed around the upper and lower stator drums, 1593, 1597, respectively, and having exposed sides, or sides lightly covered with a thin layer of non-ferrous material. Each stator in the assembly includes an inside diameter and outside diameter (not indicated by reference numbers), the stator inside diameters being slightly larger than the outside diameter of the rotor 1410, such that the rotor inserts into the stators with an acceptable clearance for free rotation of the rotor within the stators, and for optimal induction during operation. As is shown, each of the upper and lower stator coil rings, 1660, 1665 are affixed to their respective stator drum, which is, in turn, attached to a structural mounting ring, 1590, 1595, the upper of which attaches to top plate, 1600, and the bottom of which attaches to base plate, 1605.

The supportive frame for this embodiment includes an upper (top) plate 1605 and lower (base) plate 1605, each including a center bearing or bushing 1608, in which a bearing 1610 on center axle 1550 is seated. A plurality of outer columnar supports 1620 connect at connection points 1625 upper and lower plates, 1600, 1605. A plurality of levitation magnets 1680 are disposed in the distal (lower) end 1450 of the rotor 1410 and in an annular channel 1603 in the base plate 1605, and the absence of bearings or other surface contacts allows the rotor to spin on center axle with greatly reduced friction.

The substantially cylindrical rotor, 1410, has an inside diameter and an outside diameter (not indicated by reference numbers), the outside diameter being slightly smaller that the inside diameter of the upper and lower stator mounting rings, 1590, 1595. The rotor 1410 has an upper end, 1440 and a lower end, 1450, and a circumferential midline, 1460. An upper and lower set of permanent magnets, 1470, 1480 are each circumferentially arrayed in rows on the upper and lower sides, respectively, of the circumferential midline, 1460. Upper and lower structural rings, 1490, 1500 integrally connect with a medial circumferential ring 1510 with vertical slats 1520 to form framework within which the rows of magnets 1470, 1480 are disposed.

As in the earlier embodiments, this embodiment includes a magnetic drive assembly that includes a plurality of drive magnets 1530, which are also permanent magnets, and which are circumferentially disposed around the circumferential midline, 1460 and medial ring, 1510 of the rotor. The magnets are oriented with exposed poles angled rearwardly relative to the direction of rotation of the rotor. An axially oriented spindle 1540 having a center axle, 1550 spans the distance from the upper to lower edges of the rotor and is affixed to the medial ring with radially extending spokes (not shown) or a concentrically disposed solid plate or disc (not shown) which connects to the inner wall of the rotor at the circumferential midline.

Upper and lower support rings, 1630, 1635 are attached or integrally affixed to the supports 1620 to provide a structural base and ceiling for securing and sandwiching a plurality of electromagnets 1640, which angle away from the direction of rotation of the rotor so as to orient the magnetic pole 1645 (which is identical in polarity from the exposed pole of permanent magnets 1530 on rotor 1410), such that the permanent magnets 1530 are repelled and driven by the electromagnets 1640 in support rings 1630, 1635 when energized.

A sensor mounting ring 1240 has a plurality of electromagnet tripping sensors 1230 (photo coupled interrupter modules) mounted thereon. The tripping sensors are connected to a power supply circuit. The sensor mounting ring is affixed to the upper plate 1600, such that each tripping sensor corresponds to a single electromagnet, 1640. Next, a propeller vane, 1220 having photo interrupter blades 1225 corresponding in number to the number of permanent magnets 1530 in medial ring 1510, is positioned on center axle 1550, such that when blades 1225 interrupt the beams from sensors 1230, the power supply circuit causes a corresponding electromagnet 1640 to be energized, thereby creating an identical polarity to the outward facing pole of the most proximate permanent magnet 1530, and thus creating magnetic repulsion which causes rotor 1410 to spin.

As will be readily appreciated by those with skill, the principle of operation of the above-described fourth preferred embodiment is in all material respects identical to that of the first through third embodiments.

In each embodiment, the structural and operative elements are configured to enable the motor and generator to run independently of the power supply when the rotor has achieved sufficient angular momentum. In this respect, the power supply may be conceived of as a motor starting circuit which selectively and periodically energizes the electromagnet as long as necessary for the system to become self-powering and at which point the permanent magnets are the sole motive force operating on the rotor to sustain rotation. In certain systems, a shunt circuit can be connected to the output of the wire coils to function as a charging circuit. Such a circuit includes a plurality or a bank of capacitors that taps into the output circuit when the rotor is at optimal operating speed, and delivers current in pulses to the capacitors, but with a frequency that does not impose too significant a load on the rotor so as to drag it to a stop. Rather, the charging circuit is controlled so as to permit the rotor to rebuild to optimal speed after current is siphoned off. The capacitors periodically discharge into batteries.

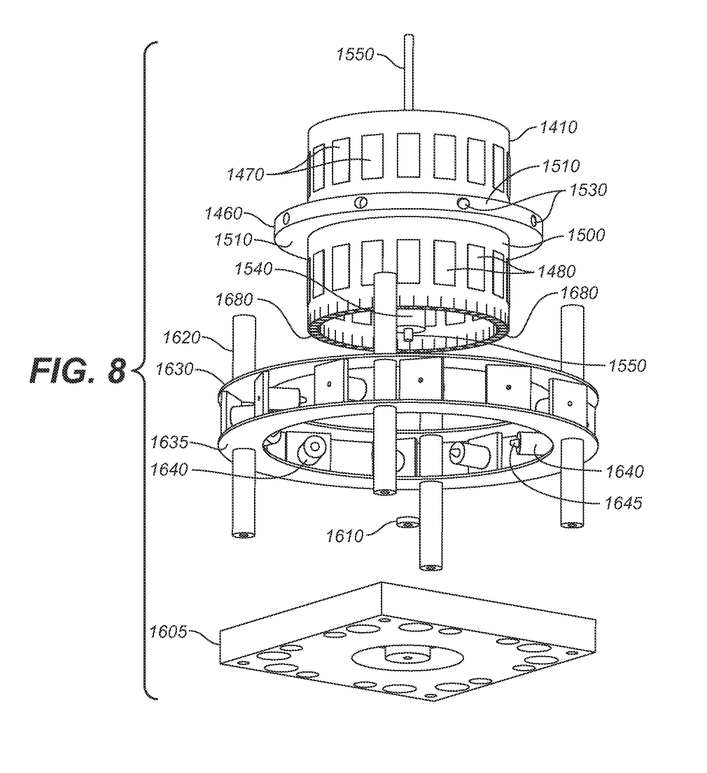

In FIG. 9 there is shown a fifth preferred embodiment of the inventive magnetically driven electric power generator. In this instance, the medial assembly of electromagnets shown in FIGS. 6-8 is replaced by a linear synchronous motor or linear induction motor ring (LSM ring) 1710 comprising a plurality of electromagnets configured in an annular array. Again, this is essentially the same device as that shown in FIGS. 6-8, but includes a substantially continuous ring of electromagnets rather than an array of a relatively small or a limited number of spaced apart magnets.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which shall be defined by the claims filed concurrently with a successor non-provisional, regular national utility patent application.

1. A magnetically driven motor and electric power generator, comprising:
a mounting frame including a base plate, a top plate, a support platform between said base plate and said top plate, and a plurality of vertical support elements joining said top plate, said base plate, and said support platform;
at least one generally cylindrical stator including a drum having an interior diameter;
a plurality of wire coils circumferentially disposed around the exterior side of said drum;
a generally cylindrical rotor axially disposed inside said at least one stator on a center axle and having an upper end, a lower end, and an outer diameter slightly smaller than the diameter of said drum such that the gap between said drum and said rotor so as to allow for free rotation of said rotor within said stator, said axle being connected at its ends in said top and said bottom.
an annular array of drive magnets disposed around said rotor and having exposed and outwardly facing poles angled rearwardly relative to the direction of rotation of the rotor when in operation;
at least one row of permanent magnets circumferentially disposed on and around said rotor in a generally annular array and aligned with said wire coils such that said permanent magnets induce electric current in said wire coils as said rotor turns;
an array of electromagnets disposed on said support platform, said electromagnets oriented with a magnetic pole having a polarity when energized that is identical to that of the exposed pole of said drive magnets on said rotor, such that the drive magnets are repelled electromagnets when energized and said rotor is driven in a predetermined direction of rotation; and
a power supply circuit that energizes each of said electromagnets to provide them with a repulsive polarity at the time and position necessary to repel a most proximate drive magnet on said rotor so as to drive the rotor in one direction.

2. The magnetically driven motor and electric power generator of claim 1, wherein said at least one stator includes a cylindrical upper stator and a cylindrical lower stator, each of which includes a substantially cylindrical body having an upper end, a lower end, an inside diameter, and outside diameter, and annular structural mounting ring, and wherein said rotor has an outer diameter slightly smaller than the interior diameter of said stators and inserts into and between said lower end of said upper stator and said upper end of said lower stator with an acceptable clearance for free rotation of the rotor within the stators.

3. The magnetically driven motor and electric power generator of claim 2, wherein said rotor further includes a circumferential midline exposed between said lower end of said upper stator and said upper end of said lower stator, and wherein said drive magnets are disposed around said circumferential midline.

4. The magnetically driven motor and electric power generator of claim 3, wherein said rotor has an upper set of permanent magnets positioned above said circumferential midline and a lower set of permanent magnets disposed below said circumferential midline.

5. The magnetically driven motor and electric power generator of claim 4, wherein said rotor includes a medial ring extending outwardly from said circumferential midline, and said drive magnets are disposed in said medial ring

6. The magnetically driven motor and electric power generator of claim 1, wherein said center axle includes a bearing at each of its upper and lower ends, each journalled in a bushing disposed in each of said base plate and said top plate.

7. The magnetically driven motor and electric power generator of claim 6, wherein said rotor is connected to said center axle at the circumferential midline with either a concentrically disposed disk or a plurality of radially extending spokes

8. The magnetically driven motor and electric power generator of claim 1, wherein said upper end of said upper stator includes a mounting ring connected to said top plate, and said lower end of said lower stator includes a mounting ring connected to said base plate.

9. The magnetically driven motor and electric power generator of claim 1, wherein said support platform includes spaced apart upper and lower support rings attached to said vertical support elements, and wherein said electromagnets are disposed between said support rings

10. The magnetically driven motor and electric power generator of claim 1, wherein said vertical support elements include columnar supports connected at connection points in each of said top and base plates

11. The magnetically driven motor and electric power generator of claim 1, further including a plurality of levitation magnets disposed in said lower end of said rotor and in an annular array on said base plate immediately under said levitation magnets in said rotor

12. The magnetically driven motor and electric power generator of claim 11, wherein said levitation magnets in said base plate are set in an annular channel formed in said base plate.

13. The magnetically driven motor and electric power generator of claim 1, further including a sensor mounting ring having a plurality of electromagnet tripping sensors mounted on said top plate and electrically coupled to said power supply circuit, each of said tripping sensors corresponding to a single electromagnet, and a propeller vane having photo interrupter blades corresponding in number to the number of drive magnets in said medial ring and connected to said center axle, such that when said photo interrupter blades interrupt beams from said tripping sensors, said power supply circuit causes a corresponding electromagnet to be energized.

14. The magnetically driven motor and electric power generator of claim 1, wherein said power supply circuit includes a plurality of tripping sensors corresponding in number to the number of drive magnets and controlled by the spatial relationship of the drive magnets to the electromagnets during rotor rotation, such that said tripping sensors allow current to be provided to each of said electromagnets and thereby create an identical polarity between the energized electromagnet and the most proximate drive magnet only at the time and position necessary to repel a corresponding drive magnet on the rotor so as to drive the rotor in one direction.

15. A magnetically driven motor and electric power generator, comprising:
a mount including a top side and a base side;
at least one generally cylindrical stator including a drum having an interior diameter;
a plurality of wire coils circumferentially disposed around the exterior side of said drum;
a generally cylindrical rotor axially disposed and centered inside said at least one stator so as to form a small gap between said stator and said rotor;
an array of drive magnets disposed on said rotor;
a plurality of permanent magnets disposed on said rotor in alignment with said wire coils such that said permanent magnets induce electric current in said wire coils as said rotor turns; and
a plurality of electromagnets spaced apart from said drive magnets positioned and oriented such that the poles of said electromagnets when energized have a polarity identical to that of the exposed poles of said drive magnets, thereby creating a repelling force between said electromagnets when energized and said drive magnets.

16. The magnetically driven motor and electric power generator of claim 13, further including a center axle to which said rotor is connected, wherein said center axle is connected at its ends to said top side and said base side of said mount.

17. The magnetically driven motor and electric power generator of claim 13, further including a plurality of levitation magnets disposed in said rotor and a plurality of levitation magnets disposed in said stator and said top and bottom sides of said mount such that said rotor is substantially centered and spaced apart from said stator and said mount.

18. The magnetically driven motor and electric power generator of claim 13, further including an electromagnet energizing circuit that energizes said electromagnets to provide them with a repulsive polarity at the time and position necessary to repel said drive magnets so as to urge said rotor in one direction.

19. A magnetically driven motor and electric power generator, comprising:
a generally cylindrical stator having an upper portion and a lower portion, and inner side and an outer side;
a plurality of wire coils disposed on said outer side of said stator;
an electric output circuit electrically coupled to said plurality of wire coils;
a generally cylindrical rotor rotatably disposed inside said stator;
a plurality of drive magnets disposed on said rotor with outwardly facing poles angled away from the direction of rotation of the rotor when in operation;
a plurality of permanent magnets disposed on said rotor and aligned with said wire coils such that said permanent magnets induce electric current in said wire coils as said rotor turns;
a plurality of electromagnets positioned around said rotor in alignment with said drive magnets and having a polarity at their respective magnetic poles when energized that matches the polarity of the magnetic poles of the exposed ends of said drive magnets on said rotor;
an electric starter circuit for selectively and periodically energizing each of said electromagnets to provide them with a repulsive polarity at the time and position necessary to repel said drive magnets; and
a shunt circuit including a plurality of capacitors for directing current from said output circuit to said capacitors and periodically discharging stored charge into storage devices.

20. The magnetically driven motor and electric power generator of claim 17, wherein said storage devices are batteries.

19. (canceled)

20. (canceled)
